(19) United States
(12) Patent Application Publication
(10) Pub. No.: US 2026/0257705 A1
(43) Pub. Date: Sep. 3, 2026

(54) METHOD AND DEVICE FOR DETERMINING THE POSITION OF A TRACKBOUND VEHICLE

(71) Applicant: Siemens Mobility GmbH, München (DE)

(72) Inventors: Christoph Seidel, München (DE); Kristian Weiss, Berlin (DE)

(21) Appl. No.: 18/842,127

(22) PCT Filed: Feb. 23, 2023
(86) PCT No.: PCT/EP2023/054607

§ 371 Date: Aug. 28, 2024

(30) Foreign Application Priority Data
Feb. 28, 2022 (DE) 10 2022 202 011.1

(51) Int. Cl. B61L 25/02; G01S 13/42

(52) U.S. Cl. CPC B61L 25/02; G01S 13/42

(57) ABSTRACT

A method determines the position of a track bound vehicle moving along a track, in particular a rail vehicle. In order to provide a method alternative to that which is known, a distance and/or an angle with respect to at least one landmark is determined by at least one sensor device on the vehicle. Digital position information which describes the course of the track and the at least one landmark in a common reference system is provided, and the digital position information is used to calculate a position of the vehicle taking the determined distance and/or angle into account. A device implements the method for determining the position.

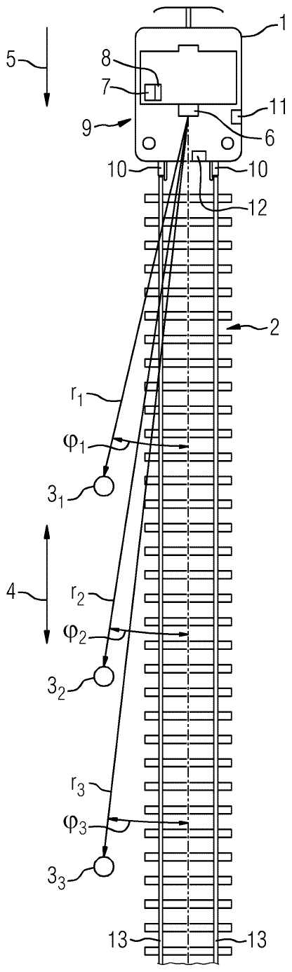

The invention relates to a method for determining the position of a vehicle that is rail-bound and moving along a travel rail, in particular a rail vehicle.

For rail-bound vehicles and in particular rail vehicles, it is important that they know their prevailing position with sufficient accuracy in order to use this for example for a train safety facility. A plurality of the facility and method mentioned in the introduction is known from the prior art, which are based for example on a satellite navigation, on position information that is read out when crossing balises, or on an odometry facility. It is also known to combine various systems in order to consequently increase the reliability of the position determination. All known methods have their weaknesses and disadvantages and alternatives are always of interest, in particular if they are simple and cost-effective.

It is therefore the object of the present invention to provide a method and a facility of the type mentioned in the introduction that offer an alternative to known position determinations.

In accordance with the invention, the object is achieved by a method for determining the position of a vehicle that is rail-bound and moving along a travel rail, in particular a rail vehicle, in which a distance and/or an angle with respect to at least one landmark is determined by at least one vehicle-side sensor facility, in which digital position information is provided that describes the course of the travel rail and the at least one landmark in a common reference system, and in which on the basis of the digital position information a position of the vehicle is calculated taking into account the determined distance and/or angle.

Furthermore, the object is achieved by a facility for determining the position of a vehicle that is rail-bound and moving along a travel rail, in particular a rail vehicle, having at least one sensor facility that can be attached on the vehicle side, by means of which it is possible to determine a distance and/or an angle with respect to at least one landmark, having at least one storage facility in which digital position information is stored that describes the course of the travel rail and the at least one landmark in a common reference system, and having at least one computing facility that is configured so as to calculate on the basis of the digital position information a position of the vehicle taking into account the determined distance and/or angle.

The solution in accordance with the invention has the advantage that with the aid of the determined distance and/or angle and the digital position information it is possible in a simple manner to calculate a precise vehicle position. For example, the vehicle-side sensor facility in accordance with the invention can already be present on the vehicle if this vehicle comprises for example obstacle recognition. Obstacle recognition facilities are provided for example in vehicles having driver assist systems or in self-driving vehicles. Furthermore, the digital position information is frequently already provided in the form of for example a digital route atlas on the vehicle, which can be used for the invention. Various landmarks such as overhead line masts or light signals and also the travel rail are contained in such a digital route atlas. The route atlases are also being permanently developed so that these route atlases become ever more detailed. It is possible to use for example a radar or lidar system as a sensor facility, alternatively however stereo cameras, UWB systems or approaches based on TDOA (time difference of arrival), AQA (angle of arrival), RTOF (roundtrip time of flight) or RSSI (received signal strength indicator) are conceivable. Since the digital position information includes both the course of the travel rail as well as the landmarks, only one landmark is required in order to calculate the vehicle position because rail-bound vehicles cannot leave the travel rail. Since for example overhead line masts on electrified routes are usually provided at a distance of approximately 50-80 meters and known sensor facilities cover this distance, it is possible at any time to calculate the position of the vehicle in the manner in accordance with the invention.

In accordance with the invention, the calculated position is used as the position of the vehicle. The distance and/or angle measurement by the sensor facility can be performed continuously and also the position calculation can be performed continuously or repeatedly. The determination of distance and/or angle with respect to at least one landmark obviously depends on the measurement region of the sensor facility. In this case, in particular the area surrounding the vehicle in the range of 150 m, for example, is detected by the sensor facility.

The solution in accordance with the invention can be developed by advantageous embodiments as described below.

The position of the vehicle can thus be selected from the position information for the course of the travel rail so that a difference between a distance and/or angle, which are calculated from digital position information, and the distance and/or angle that is determined by the sensor facility is minimized. This has the advantage that such a subtraction can easily be achieved in an algorithm and can be automatically implemented by means of corresponding software that implements the method in accordance with the invention. For example, this can be implemented by minimizing the smallest error squares. A check is performed for all positions during the course of the travel rail that are provided in the digital position information or have been selected therefrom as to whether the distance and/or angle with respect to a landmark matches the real measured distance and/or angle. The position for which this comparison best suits is then assumed as the calculated position.

In order to guarantee unambiguous and rapid position determination, it is possible from an overall quantity of the digital position information to make a preselection that is used in the calculation of the position of the vehicle. In the case of using an overall quantity of the digital position information, in other words for example the entire digital route atlas, it is possible for the position determination to be ambiguous because the landmarks such as overhead line masts are not clearly differentiable and if so for there to be two or more times the measured distance to a point of the travel rail. Due to the preselection, the ambiguity can be ruled out. The preselection can be for example a section of the route atlas having a determined section of the travel rail.

Furthermore, the preselection can be determined on the basis of an assumed position of the vehicle, which has been determined by an alternative position determining method, which is based for example on a satellite navigation system, crossing a balise or an odometry facility. Alternatively, it could also be possible to use other information such as for example timetable data in order to make the preselection.

In order to further increase the clarity in the position determination, the distance and/or the angle with respect to at least one landmark can only be determined in a region in a direction of travel ahead of the vehicle. For this purpose, it is then also possible to use sensor facilities, the sensor systems of which due to their position can only view forwards. An alternative to this would be for example an environment sensor that also detects a rearward region to the rear of the vehicle.

In a further advantageous embodiment, the digital position information can also describe an orientation of the travel rail and/or a clearance of the vehicle with respect to the travel rail. This has the advantage that the accuracy of the position determining method in accordance with the invention can be further increased. In order to likewise increase the accuracy, it is possible during the calculation of the position of the vehicle to take into account an orientation of the sensor facility relative to the vehicle.

Furthermore, during the calculation of the position of the vehicle it is possible to take into account a direction of travel of the vehicle. In the case of specific landmarks, it is thus possible to further increase the clarity.

In one advantageous embodiment, the distance and the angle with respect to at least one landmark can be determined by the sensor facility and the position of the vehicle can be calculated on the basis of the digital position information taking into account the determined distance and angle, wherein the distance and the angle are weighted differently in the calculation. This has the advantage that, in the case of different sensors for distance and angle, for example, it is possible to take into account their possible different accuracies.

In one advantageous embodiment of the facility in accordance with the invention for position determination, the sensor facility can comprise at least one radar sensor and/or one lidar sensor by means of which it is possible to determine the distance and the angle with respect to at least one landmark. This has the advantage that radar and lidar sensors can determine both the distance as well as the angle with respect to a landmark. In the case of other sensors, it is possible that two sensors must be used in order to determine distance and angle. A support by the speed measurement of the landmarks, for example by a radar, can likewise be used as a support of the angle estimation by applying trigonometric calculations.

A tracking or an iterative repetition including the existing measurement result can lead to a refinement and to more stable or more precise results.

In order to further improve the facility in accordance with the invention, this facility can be designed so as to implement the method in accordance with the invention according to one of the above-mentioned advantageous developments.

The invention also relates to a rail-bound vehicle, in particular a rail vehicle, having at least one facility for position determination. In accordance with the invention, this facility is designed for position determination according to one of the above-mentioned embodiments of the facility in accordance with the invention for position determination.

Furthermore, a computer program product having program commands for carrying out the mentioned method in accordance with the invention and/or its exemplary embodiments is claimed, wherein it is possible by means of the computer program product in each case to implement the method in accordance with the invention and/or its exemplary embodiments.

Furthermore, a provision apparatus for storing and/or providing the computer program product is claimed. The provision apparatus is provided for example as a data carrier that stores and/or provides the computer program product. Alternatively and/or in addition, the provision apparatus is for example a network service, a computer system, a server system, in particular a distributed computer system, a cloud-based computer system and/or virtual computer system that preferably stores and/or provides the computer program product in the form of a data stream.

The provision takes place for example as a download in the form of a program data block and/or command data block, preferably as a file, in particular as a download file, or as a data stream, in particular as a download data stream, of the complete computer program product. This provision can also take place for example however as a partial download that is made up of multiple parts and in particular is downloaded via a peer-to-peer network or as a data stream. Such a computer program product is input for example using the provision apparatus in the form of a data carrier into a system and executes the program commands so that the method in accordance with the invention is implemented on a computer or the preparation device is configured in such a manner that this generates the workpiece in accordance with the invention.

Below, the invention is further explained with reference to the attached drawing.

The single FIGURE illustrates a schematic illustration of a vehicle in accordance with the invention in an exemplary embodiment.

The invention is explained with reference to the FIG. below with reference to the exemplary embodiment of the vehicle in accordance with the invention and the facility in accordance with the invention for position determination.

A vehicle 1 in accordance with the invention moves along a travel rail 2. The vehicle 1 here is a rail vehicle, for example a train, a locomotive, a tram or a subway train. The travel rail 2 corresponds to a railway on which the vehicle 1 travels in a rail-bound manner.

In the area surrounding the travel rail 2 there are landmarks 3 that in the exemplary embodiment in the FIG. are to be for example overhead line masts. The landmarks can alternatively however also be other prominent objects or buildings such as trees, electrical buildings, light signals or similar. In each case, the landmarks 3 are fixedly connected to the ground and consequently can be used for a reliable orientation. In the FIGURE, the landmarks 3 are only arranged on one side of the travel rail 2. Obviously, the landmarks can also be arranged on both sides of the travel rail and at different distances 4 with respect to one another and with respect to the travel rail 2. The exemplary landmarks 3 in the FIGURE, which are to represent overhead line masts, are arranged at an essentially uniform spacing 4 with respect to one another that amounts to approximately 60 meters.

The vehicle 1 moves in a direction of travel 5 along the travel rail 2. The vehicle 1 comprises a sensor facility 6, a computing facility 7 and a storage facility 8. The sensor facility 6, the computing facility 7 and the storage facility 8 together form a facility 9 in accordance with the invention for position determination.

The sensor facility 6 comprises a radar sensor (not illustrated) and using this sensor facility detects a measurement region that is located in the direction of travel 5 ahead of the vehicle 1. The sensor facility 6 during operation determines a distance r and an angle φ with respect to each landmark 3. The distance r is the relative distance between the sensor facility 6 and the landmark 3. The angle φ is the angle between a straight line from the sensor facility 6 with respect to the landmark 3 and a further straight line from the sensor facility 6 in the direction of travel 5. In the exemplary embodiment in the FIGURE, the sensor facility 6 is arranged in the center of the vehicle 1. In the exemplary embodiment in the FIGURE, a distance r and an angle φ is determined by the sensor facility 6 with respect to each of the three illustrated landmarks 3. In order to more easily make a distinction, the three illustrated landmarks 3 and their associated distances r at the angle φ are provided in each case with different indices.

The computing facility 7 in the exemplary embodiment in the FIGURE is part of a computer (not illustrated) and is designed so as to calculate the vehicle position. The computing facility 7 can also assume further computing tasks of the vehicle 1. For example, the computing facility 7 can be a vehicle computer of the vehicle 1, which completes various tasks.

The storage facility 8 in the exemplary embodiment in the FIGURE is likewise part of the computer, the storage facility is embodied for example in the usual manner as an SSD storage device or hard disk. Alternatively, the storage facility 8 can also be stored externally of the vehicle 1, for example on a cloud server, and connected to the computing facility 7.

Digital position information is stored on the storage facility 8, which describes the course of the travel rail 2 and the landmarks 3 in a common reference system. The common reference system can be for example a geocoordinate system in which, nowadays, positions are usually disclosed. The position information is stored for example in the form or as part of a route atlas.

The vehicle 1 furthermore comprises an odometry facility 11 and a balise reading facility 12. The odometry facility 11 and the balise reading facility 12 are designed in the usual manner and are likewise used to determine the position for the vehicle 1.

When the balise reading facility 12 crosses a balise (not illustrated) that is arranged in the travel rail 2, the balise reading facility 12 reads position information from the balise and relays the position information to the odometry facility 11. The odometry facility 11 determines a path of the vehicle 1 that is travelled after crossing the balise and can consequently indicate a position of the vehicle 1 at any point in time. In order to increase the reliability of the position determination of the vehicle 1, the position of the vehicle 1, which is determined by the odometry facility 11, is verified by the position that is determined by the facility 9 in accordance with the invention for position determination.

The method in accordance with the invention for position determination is described below.

Initially, the vehicle-side sensor facility 6 measures the distance r₁ and the angle φ₁ with respect to the landmark r₁. For the sake of simplicity, only the landmark 31 is used for the description of the method in accordance with the invention, however it is possible alternatively or additionally to also use the other landmarks 32 and 33.

The computing facility 7 allocates this measurement of the sensor facility 6 subsequently by means of computing operations to one of the landmarks 3 in the digital route atlas.

The digital route atlas having the digital position information with regard to the course of the travel rail 2 and the landmarks 3 is made available to the computing facility 7 by the storage facility 8. For the position determination, the computing facility 7 calculates a position during the course of the travel rail 2 within the digital position information with which the measured spacing r₁ and the angle φ₁ matches most precisely. This is determined in a computational manner by virtue of the fact that a difference between a distance and angle, which are calculated from the digital position information, to the distance r₁ and angle φ₁, which are determined from the sensor facility 6 is minimized. For the travel rail, the digital position information is provided for example in the form of an interrelated quantity of points, each having a unique identifier. The travel rail is stored as a chain of identifiers so that the quantity of points is connected and essentially there are no gaps.

For the allocation, it is possible to use known association methods such as the Hungarian algorithm. Known association methods are based for example on evaluation of Euclidean distances or the Mahalonobis distance.

Furthermore, the course of the travel rail 2 that is known from the route atlas can be transferred into functions s(d) and φ(d) that are dependent upon a scalar. On the basis of the function s(d) it is possible to determine the position on the basis of the respective route kilometers. The function φ(d) in turn describes the orientation of the travel rail 2 in dependence upon the distance travelled. The respective landmarks 3 are described for example by a vector p_{l,i}. A value x can describe a possible degree of freedom due to a clearance of the vehicle 1 with respect to the travel rail 2. This degree of freedom can lead for example to an S-course of the vehicle 1. This can cause the vehicle 1 to yaw and thus for the sensor facility 6 to yaw. A value range of the value x is limited to a few degrees by the rails 13 of the travel rail 2 so that the deviation is limited. These conditions are summarized in the following formula, which is to be minimized in the determination of the calculated vehicle position.

The formula only expresses an exemplary embodiment of the method in accordance with the invention. Obviously, terms and variables in the formula can be omitted or described differently and continue to embody the method in accordance with the invention.

$${arg min}_{d , α} {\sum }_{i = 1}^{N} [ {ω}_{r , i} {‖ {‖ s ( d ) - R ( ϕ ( d ) ) t - {p}_{l , i} ‖}_{2} - {r}_{m , i} ‖}_{2}^{2} + {ω}_{φ , i} {‖ arctan 2 ( {p}_{l , i} - s ( d ) ) - {φ}_{m , i} - β - ϕ ( d ) - α ‖}_{2}^{2} ]$$

s(d) route, depending on routes travelled km [2×1]
pₗᵢ mapped position of the landmarks i [2×1]
ωᵢ uncertainty (weighting)
φ(d) route orientation
φ,r angle and distance measurement
β sensor orientation
R, t rotation and translation relative to the rail
α play on the rail

In the formula, the front and rear term are weighted differently so that the measurement of the distance and the measurement of the angle, which are included in the front or the rear term, are weighted differently by means of the factors w. This can be helpful for example if these measurements have a different accuracy.

In the embodiment described here, both the distance r as well as also the angle φ is determined and used in the calculation. The method in accordance with the invention can however also be applied if only one of the two angle and distance is present. In the formula mentioned above, then accordingly either the front or the rear core is omitted.

The translation t and the rotation R from a pivot point, which is regarded as a fixed position on the travel rail 2, and the twisting β of the sensor facility 6 with respect to the direction of travel 5 are installation parameters on the vehicle 1. The weighting ω of the individual measurements can be used in order to set for example measurements of different accuracy in relation to one another, as described above. The value a describes the possible degree of freedom due to the clearance on the rail, which can lead for example to an S-course of the vehicle.

The above-mentioned formula is based on absolute position measurements from the sensor facility. Alternatively, the relative position measurements can of course also be available, which provide for example Cartesian coordinates. For this purpose, the above formula would be adapted accordingly.

1-15. (canceled)

16. A method determines a position of a vehicle that is rail-bound and moving along a travel rail, which comprises the steps of:
determining a distance and/or an angle with respect to at least one landmark by at least one vehicle-side sensor facility;
providing digital position information that describes a course of the travel rail and the at least one landmark in a common reference system; and
calculating, on a basis of the digital position information the position of the vehicle, taking into account the distance and/or the angle determined.

17. The method according to claim 16, which further comprises selecting the position of the vehicle from the position information for a course of the travel rail so that a difference between the distance and/or the angle, which are calculated from the digital position information, and the distance and/or the angle that is determined by the vehicle-side sensor facility is minimized.

18. The method according to claim 17, wherein from an overall quantity of the digital position information, a preselection is made that is used in the calculating of the position of the vehicle.

19. The method according to claim 18, which further comprises determining the preselection on a basis of an assumed position of the vehicle, which has been determined by an alternative position determining method, which is based on a satellite navigation system, crossing a balise or an odometry facility.

20. The method according to claim 16, wherein the distance and/or the angle with respect to the at least one landmark can only be determined in a region in a direction of travel ahead of the vehicle.

21. The method according to claim 16, wherein the digital position information also describes an orientation of the travel rail and/or a clearance of the vehicle with respect to the travel rail.

22. The method according to claim 16, wherein during the calculating of the position of the vehicle an orientation of the at least one vehicle-side sensor facility relative to the vehicle is taken into account.

23. The method according to claim 16, which further comprises taking into account during the calculating of the position of the vehicle a direction of travel of the vehicle.

24. The method according to claim 16, wherein the distance and the angle with respect to at least one landmark is determined by the at least one vehicle-side sensor facility and the position of the vehicle is calculated on a basis of the digital position information taking into account the distance and the angle determined, wherein the distance and the angle are weighted differently in the calculation.

25. The method according to claim 16, wherein the vehicle is a rail vehicle.

26. A facility for determining a position of a vehicle that is rail-bound and moving along a travel rail, the facility comprising:
at least one sensor system attached on a vehicle side, by means of said at least one sensor system it is possible to determine a distance and/or an angle with respect to at least one landmark;
at least one memory in which digital position information is stored that describes a course of the travel rail and the at least one landmark in a common reference system; and
at least one computer configured so as to calculate on a basis of the digital position information the position of the vehicle taking into account the distance and/or the angle determined.

27. The facility according to claim 26, wherein said at least one sensor system includes at least one radar sensor and/or one lidar sensor by means of which it is possible to determine the distance and the angle with respect to the at least one landmark.

28. The facility according to claim 26, wherein the facility is configured to perform a method that determines the position of the vehicle, the facility is programmed to:
determine the distance and/or the angle with respect to the at least one landmark by said at least one sensor facility;
provide the digital position information that describes the course of the travel rail and the at least one landmark in said at least one memory; and
calculate, on the basis of the digital position information the position of the vehicle, taking into account the distance and/or the angle determined.

29. The facility according to claim 26, wherein the vehicle is a rail vehicle.

30. A rail-bound vehicle, comprising:
at one said facility for position determination according to claim 26.

31. A non-transitory computer readable medium having computer executable instructions for implementing the method according to claim 16.
